(19) United States
(12) Patent Application Publication
(10) Pub. No.: US 2003/0169435 A1
(43) Pub. Date: Sep. 11, 2003

(54) Printer control apparatus, printer control method, and printer

(75) Inventors: Takakazu Kobayashi, Kawasaki (JP); Motohiro Tokairin, Kawasaki (JP)

Correspondence Address: ARMSTRONG,WESTERMAN & HATTORI, LLP, 1725 K STREET, NW, SUITE 1000, WASHINGTON, DC, 20006, US

(73) Assignee: FUJITSU LIMITED, Kawasaki (JP)

(21) Appl. No.: 10/283,290

(22) Filed: Oct. 30, 2002

(30) Foreign Application Priority Data
Mar. 7, 2002 (JP) 2002-62183

(51) Int. Cl. G06F 15/00; B41B 1/00

(52) U.S. Cl. 358/1.2; 358/1.9

(57) ABSTRACT

A printer control apparatus performs printing control while converting print density within a page, to convert print density at low cost without changing the print resource. The apparatus includes a detecting unit for detecting a bar code pattern for which density should be converted from the bit map data, and the expanding unit for changing the number of data expansion dots according to the detection result. Since the print density of a specified pattern in a page can be changed from the print density of the other area, the present invention can be implemented without changing the print assets and command system at the host side, and without changing bit map expansion processing and bit map expansion density of the printer controller.

### BACKGROUND OF THE INVENTION

1. Field of the Invention

The present invention relates to a printer control apparatus, a printer control method, and a printer for generating and printing bit map data according to print data, and more particularly to a printer control apparatus, printer control method and printer for printing data by changing the print density of a specified print data to other print density of the print data.

2. Description of the Related Art

As the data processing speed and communication speed of computers improves, various modes of printing are required for printers which output data. A printer analyzes (emulates) print data (commands, data) sent from the host, expands this print data into bit map data, then prints on a medium with a printer engine.

FIG. 22 is a block diagram of a conventional printer system. The printer 200 which receives a print instruction from the host 100 is comprised of a controller 202, mechanism control section 204, and printer engine 206 which includes an LED print head.

The print instruction from the host 100 is received by the input buffer 210 of the controller 202. In the controller 202, the print instruction of the input buffer 210 is analyzed by the analysis section 220, and is converted into bit map data by the character and pattern generation section 230 according to the analysis result. The converted bit map data is expanded in the page buffer for output (bit map memory) 240, and the bit map data for one page is output from the video interface section 250 to the mechanism control section 204.

The mechanism control section 204 controls the printer engine 206. In terms of the flow of bit map data, the output data from the video interface section 250 is received by the video interface reception buffer 260 of the mechanism control section 204, then is converted into an LED drive signal by the LED head interface conversion section 270. The LED print head of the printer engine 206 is driven by this LED drive signal, and an image is formed on the photosensitive drum of the printer engine 206, and is printed by a known electro-photographic process.

For such printers, printers having such a specific print density as 240 dpi or 400 dpi which can print only at this print density, or printers having both 240 dpi and 400 dpi print density which are switched in page units (e.g. Japanese Patent Laid-Open No. 7-323608), are known. For example, when a bank transfer handling slip 300 is printed on one page, as shown in FIG. 23, both the bar code part 302 and the character part 304 are printed with a same print density. With a 240 dpi print density, the bar width of the bar code section 302 is 0.106 mm.

The bar code part 302, on the other hand, requires a specified resolution for the bar code reader to read it, and in the case of the EAN(Electronic Article Numbering)-128 Bar Code Specification, which is an international standard, for example, a 0.169 mm bar width (module width) is required. This means that conventional 240 dpi printing does not conform to the printing of bar codes under such a specification.

In order to conform to such a requirement, a method of replacing with a printer having a high print density (e.g. 400 dpi) has been proposed. Another method proposed is where bit map expansion is performed by partially changing the print density by the page buffer 240, where the character command is expanded at 240 dpi , and the bar code command is expanded at 300 dpi by the setup command during the analysis of the print command from the host (e.g. Japanese Patent Laid-Open No. 7-177348).

However, in the case of a method of replacing with a printer having a high print density, the print resources (that is, print data, especially print position) of the host 100 must also be replaced with a 400 dpi print density, which may involve an enormous data change, and a burden on the user.

In the case of the method of partially converting the print density by the page buffer 240, such a setting must be performed at the host 100, and the commands of the user system must be changed. To switch the bit map density by the page buffer, the processing speed of the controller must be increased, and a page buffer suitable for high print density is required, which increases the cost enormously.

### SUMMARY OF THE INVENTION

With the foregoing in view, it is an object of the present invention to provide a printer control apparauts, a printer control method, and a printer using them for printing with changing the print density of a pattern from the print density of the other pattern when necessary without changing the current print resources.

It is another object of the present invention to provide a printer control apparatus, a printer control method, and a printer using these for printing with changing the print density of a pattern from the print density of the other patterns when necessary without changing the resolution of the page buffer.

It is still another object of the present invention to provide a printer control apparatus, a printer control method, and a printer using these for printing with changing the print density of a bar code from the print density of characters and lines without changing the current print resources.

To achieve these objects, the printer control apparatus of the present invention includes a memory for storing bit map data which is developed at a predetermined print density, a pattern detecting unit for scanning the data of the memory by a predetermined detection window, and detecting a pattern for which print density is changed, and a print density converting unit for changing the number of data expansion dots of the bit map data of the pattern from the number of data expansion dots of the bit map data of an area other than the above pattern according to the above detection result, so as to expand the bit map data.

The printer control method according to the present invention is a printer control method for generating bit map data according to the print data, and outputting it to the printer engine, including a step of developing the bit map data in a memory at a predetermined print density, a step of scanning the data of the memory by a predetermined detection window, and detecting a pattern for which print density is changed, and a print density converting step for changing the number of data expansion dots of the bit map data of the pattern from the number of data expansion dots of the bit map data of an area other than the above pattern according to the above detection result, so as to expand the bit map data.

The printer of the present invention includes a memory for storing bit map data developed at a predetermined print density, a pattern detecting unit for scanning the data of the memory by a predetermined detection window, and detecting a pattern for which print density is changed, a print density converting unit for changing the number of data expansion dots of the bit map data of the pattern from the number of data expansion dots of the bit map data of an area other than the above pattern according to the above detection result, so as to expand the bit map data, and a printer engine for printing the expanded bit map data onto a medium.

According to the present invention, a specific pattern is detected from the bit map data, and the number of data expansion dots is changed between this pattern and an area other than this pattern, so printing with changing the print density is possible. The present invention can be implemented without changing the print resource and command system at the host side, and also without changing the bit map expansion processing and the bit map expansion density of the printer controller. Therefore the present invention can be implemented merely by changing the printer side without changing the user system, and can be implemented at low cost without increasing the processing speed of the controller and memory capacity very much.

According to the present invention, it is preferable that the above mentioned pattern detecting unit detects the start pattern and the stop pattern of a bar code, and the above mentioned print density converting unit expands the bit map data by increasing the number of data expansion dots of the bit map data of an area sandwiched between the start pattern and stop pattern to be more than the number of data expansion dots of the bit map data of an area other than the above mentioned area. As a result, the line width of the bar code can be printed thicker without changing the print resources.

Also according to the present invention, it is preferable that the above mentioned pattern detecting unit recognizes the pattern of the detection windows as the start pattern when the pattern of the detection window matches the start pattern at the point when the detection window scans for a predetermined number of dots in the main scanning direction after detecting that the pattern of the detection window is a blank pattern, so the start pattern can be detected at high precision even by a small sized window.

Also according to the present invention, it is preferable that the pattern detecting unit confirms the detection of the bar code by counting the number of dots from the point when the start pattern is detected to the point when the stop pattern is detected, so the stop pattern can be detected at high precision even by a small sized window.

Also according to the present invention, it is preferable that the above mentioned print density converting unit expands the bit map data by increasing the number of data expansion dots of the bit map data from the start pattern to be more than the number of data expansion dots of the bit map of an area other then the above mentioned area according to the detection of the start position, so the print density converting operation can be executed in parallel with the detecting operation.

Also according to the present invention, it is preferable that the print density converting unit inhibits the output of the data where the bit map data is expanded by increasing the number of data expansion dots of the bit map data from the start pattern to be more than the number of data expansion dots of the bit map data of an area other than the above mentioned area when the pattern detection unit does not confirm the bar code detection, so the output of the expanded data based on a detection error can be prevented.

Also according to the present invention, it is preferable that the above mentioned pattern detecting unit judges whether the bar code is a horizontal bar code or vertical bar code, and the print density converting unit changes the data expansion direction according to the judgment result, so as to implemented horizontal and vertical print density conversion.

### BRIEF DESCRIPTION OF THE DRAWINGS

FIG. 1 is a block diagram depicting a printer according to an embodiment of the present invention;

FIG. 2 is a diagram depicting a configuration of a printer engine of the printer in FIG. 1;

FIG. 3 is a diagram depicting a configuration of the bar code detecting section in FIG. 1;

FIG. 4 is a diagram depicting a bar code specification for an embodiment of the present invention;

FIG. 5 is a diagram depicting the bar code in FIG. 4;

FIG. 6 is a flow chart depicting the bar code detecting processing in FIG. 3;

FIG. 7 is a diagram depicting the bar code detecting operation in FIG. 3;

FIG. 8 is a diagram depicting the start detecting operation of the bar code in FIG. 7;

FIG. 9 is a diagram depicting the stop detecting operation of the bar code in FIG. 7;

FIG. 10 is a diagram depicting the horizontal bar code expanding operation of the data expanding section in FIG. 1;

FIG. 11 is a diagram depicting the vertical bar code expanding operation of the data expanding section in FIG. 1;

FIG. 12 is a block diagram depicting the print density converting mechanism according to an embodiment of the present invention;

FIG. 13 is a diagram depicting a configuration of the flag memory write controlling section in FIG. 12;

FIG. 14 is a diagram depicting the bar code detection of the control section in FIG. 13;

FIG. 15 is a diagram depicting the bar code correction detecting operation of the control section in FIG. 13;

FIG. 16 is a diagram depicting the operation of the bar code detection in FIG. 12;

FIG. 17 is a diagram depicting the horizontal bar code correction operation in FIG. 12;

FIG. 18 is a diagram depicting the operation of the vertical bar code period managing section in FIG. 13;

FIG. 19 is a diagram depicting the operation of the vertical bar code detection in FIG. 12;

FIG. 20 is a block diagram depicting the print density converting mechanism according to another embodiment of the present invention;

FIG. 21 is a diagram depicting the bar code detection operation in FIG. 20;

FIG. 22 is a diagram depicting a configuration of prior art; and

FIG. 23 is a diagram depicting prior art.

### DESCRIPTION OF THE PREFERRED EMBODIMENTS

Embodiments of the present invention will now be described with reference to the accompanying drawings, in the sequence of printer, print density converting method, print density converting mechanism of the first embodiment, print density converting mechanism of the second embodiment, and other embodiments.

[Printer]

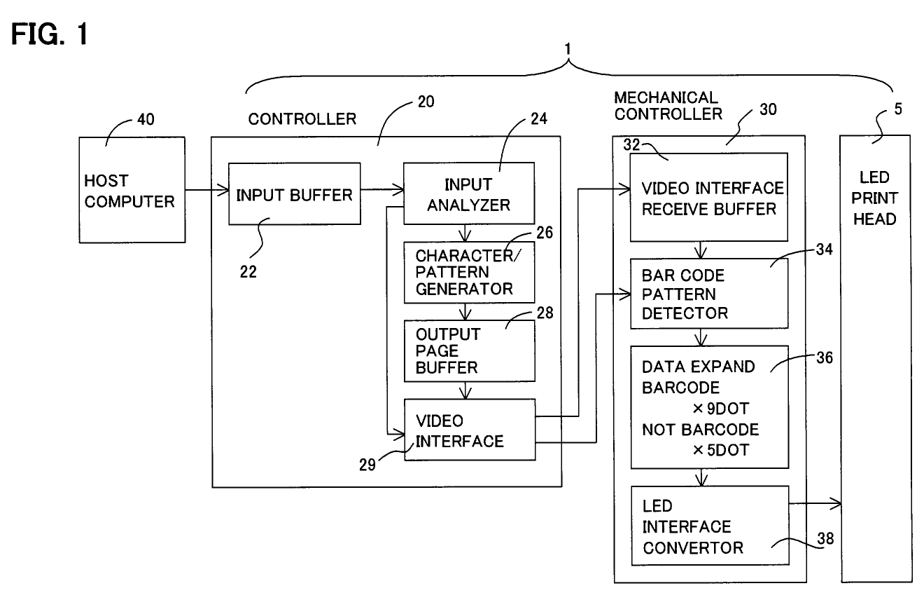

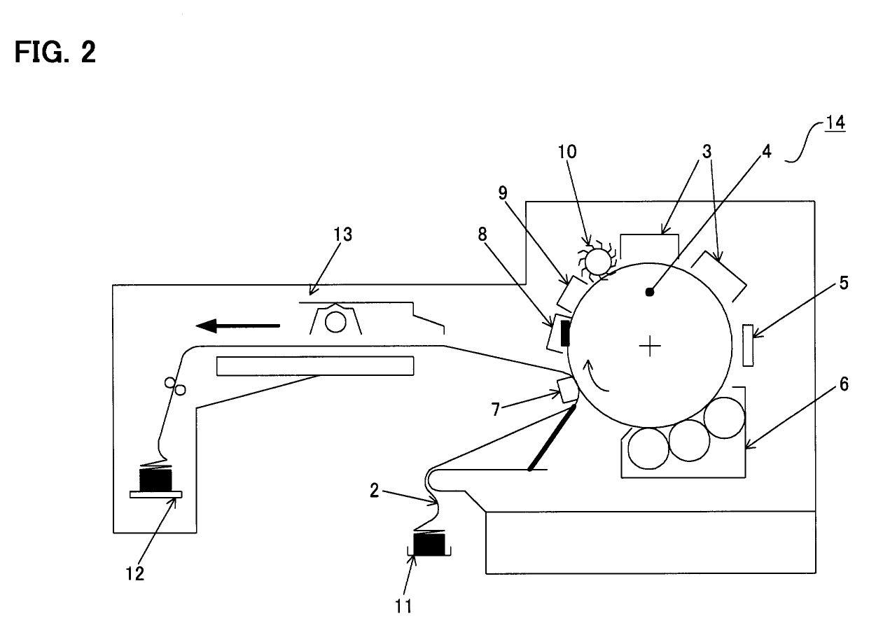

FIG. 1 is a block diagram depicting an embodiment of the printer of the present invention, and FIG. 2 is a diagram depicting a configuration of the printer engine in FIG. 1.

FIG. 1 and FIG. 2 show an electro-photographic printer 1 which handles continuous document forms as a printer according to an embodiment of the present invention. The printer 1 is connected to such a host 40 as a main frame/work station/personal computer via such an interface as a network.

The printer 1 is comprised of a printer controller 20, mechanism control unit 30, and an electro-photographic printer engine 14. The printer engine 14 prints on continuous paper 2. The printer controller 20 analyzes the command from the host 40, and performs bit map expansion. The mechanism control unit 30 controls the printer engine 14 according to the instruction of the printer controller 20.

First the configuration and operation of the printer engine 14 will be described with reference to FIG. 2. The continuous paper (folding paper) 2 stacked on the paper hopper 11 is continuously fed by the transporting system, and is housed in the stacker 12 via the transfer unit 7 and fixing unit 13. The photosensitive drum 4, which rotates in the clockwise direction, is uniformly charged by the charging unit 3, then the image is exposed by the optical system (in this case, the LED print head) 5. By this, an electrostatic latent image according to the image is formed on the photosensitive drum 4. The electrostatic latent image on the photosensitive drum 4 is developed by the developing unit 6, then the toner image of the photosensitive drum 4 is transferred to the continuous paper 2 by the transfer unit 7.

After transfer, the charge of the photosensitive drum 4 is removed by the charge removing unit 9, and residual toner is cleaned by the cleaner blade 8 and cleaner brush 10. The continuous paper 2, to which the toner image is transferred, is housed in the stacker 12 after flash fixing performed by the flash fixing unit 13.

Now the printer controller 20 and the mechanism control unit 30 of the printer 1 will be described with reference to FIG. 1. The printer controller 20 is comprised of an input buffer 22 for receiving the print instruction (print data) from the host 40, an input (print) analyzing unit (emulator) 24 for analyzing the print instruction of the input buffer 22, a character/pattern creating unit 26 for creating character and image patterns based on the analysis result of the input analyzing unit 24, a page buffer for output (bit map memory) 28 for expanding the created character patterns and image patterns in bit map format, and a video interface unit 29 for reading the bit map data of the page buffer for output 28, and outputting the bit map data as video data.

When the host 40 has a 240 dpi print resource (print data), the character/pattern creating unit 26 creates 240 dpi character and image (line, image) patterns, and the page buffer for output 28 is comprised of a 240 dpi page buffer in page units.

The mechanism control unit 30 is comprised of a video interface receive buffer 32 for receiving video data from the video interface unit 29, a bar code pattern detecting unit 34 for detecting the bar code pattern from the data of the receive buffer 32, data expanding unit 36, and an LED head interface converting unit 38.

When the LED print head 5 is a 1200 dpi print head, the data expanding unit 36 expands one dot of the bar code pattern to 9 dots, and one dot of an area other than the bar code pattern to five dots, based on the output of the bar code pattern detecting unit 34.

For example, when the resolution of 240 dpi data is converted into 1200 dpi data, one dot of 240 dpi is expanded to 1200/240=5 dots for an area other than the bar code pattern, but for the bar code pattern, one dot of 240 dpi is expanded to 9 dots. In other words, in terms of 240 dpi , one dot of the bar code pattern is converted into 1.8 times the size of the one dot of an area other than the bar code pattern.

Therefore, the bar code pattern and an area other than the bar code pattern can be printed at a different print density. So a one dot width of the bar code pattern is 0.191 mm, which is sufficient to satisfy the EAN-128 Barcode Specification. In other words, the print density of the specified pattern area in a page can be changed from the print density of the other area.

The present invention can be implemented without changing the print resource and command system at the host 40 side, and without changing the bit map development processing and bit map development density of the printer controller. Therefore the present invention is implemented merely by making a change at the printer side, without changing the user system, and can be implemented at low cost without increasing the processing speed and memory capacity of the controller very much.

The presence of a bar code is notified from the host 40 in page units, so that the analysis unit 24 analyzes this notice, and controls the operation of the bar code pattern detecting unit 34 via the video interface unit 29. When the notice that a bar code exists is received, the bar code pattern detecting unit 34 is enabled, and when the notice that the bar code does not exist is received, the operation of the bar code pattern detecting unit 34 is stopped. As a result, power consumption due to the operation of the detection circuit is decreased.

[Print Density Converting Method]

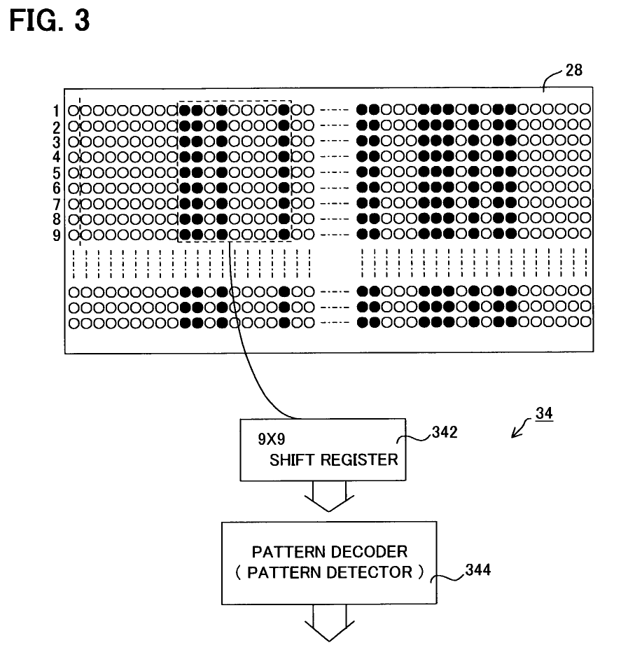

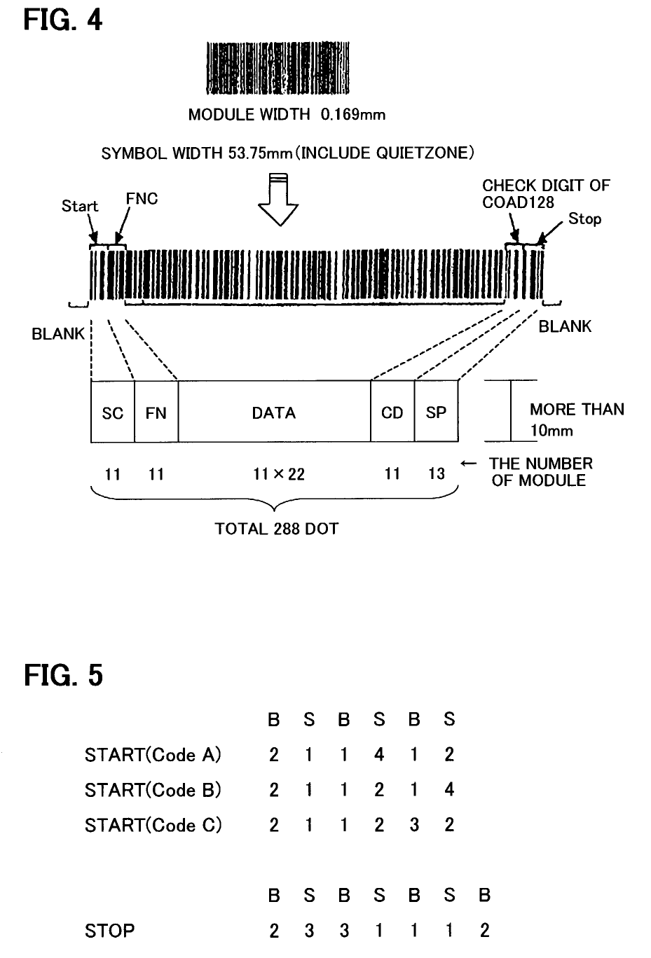

Now the above mentioned print density converting method will be described. FIG. 3 is a block diagram depicting the bar code pattern detecting section of an embodiment of the present invention, FIG. 4 is a diagram depicting a bar code of an embodiment of the present invention, and FIG. 5 is a diagram depicting the start/stop code of the bar code in FIG. 4.

As FIG. 3 shows, the bar code pattern detecting unit 34 is comprised of an n×n (in this case 9×9) shift register 342, which constitutes the window for the pattern detection of the page buffer (bit map memory) 28 and a pattern decoder 344 which holds the registered pattern to be detected, collates a pattern of a window and a registered pattern, and detects the pattern.

In other words, the data of the page buffer 28 is sequentially scanned by the n×n detection window in the main scanning direction, is collated with the registered pattern, and the pattern to be detected (in this case a bar code pattern) is detected.

Now a bar code as an embodiment of the detection pattern of the present invention will be described with reference to FIG. 4 and FIG. 5 using a EAN-128 specified bar code. As FIG. 4 shows, the EAN-128 specified bar code has 288 dots (modules) in total length, and has blanks before and after it. The bar code is comprised of 11 modules of start code SC, function code FN, 11×22 modules of data, 11 modules of check digit CD, and 13 modules of stop code SP.

As FIG. 5 shows, there are three types of start codes, where the code A is comprised of two modules of bar (B), one module of space (S), one module of bar (B), four modules of space (S), one module of bar (B), and two modules of space (S). The code B is comprised of two modules of bar (B), one module of space (S), one module of bar (B), two modules of space (S), one module of bar (B), and four modules of space (S). The code C is comprised of two modules of bar (B), one module of space (S), one module of bar (B), two modules of space (S), three modules of bar (B), and two modules of space (S).

The stop code is comprised of two modules of bar (B), three modules of space (S), three modules of bar (B), one module of space (S), one module of bar (B), one module of space (S), and two modules of bar (B).

In the present invention, an entire pattern of the bar code is detected, but the start code of the bar code and the stop code of the bar code are detected using a bar code specification with such a configuration, and the range sandwiched by the start and stop codes is judged as the bar code area.

The start code is 11 modules, the stop code is 13 modules, and the height of the bar code is 10 mm (about 100 dots at 240 dpi ), and collating with a pattern of this size increases the collation size and decreases the collation speed.

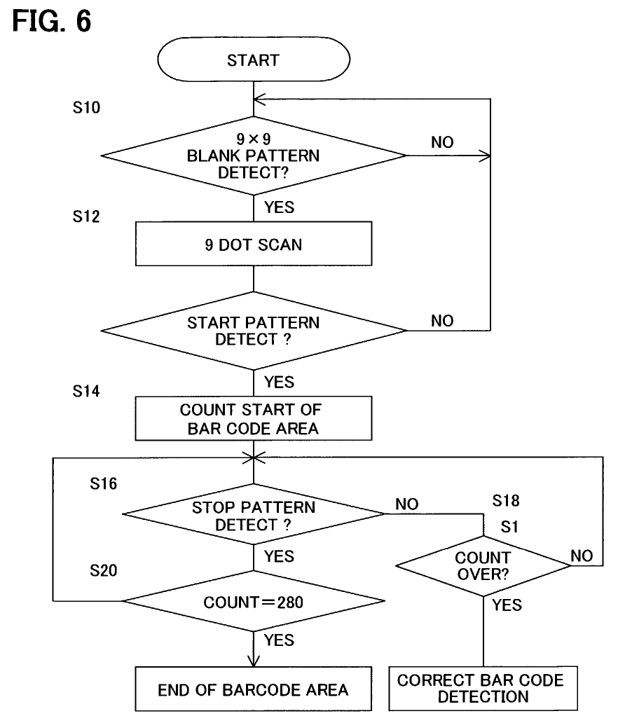

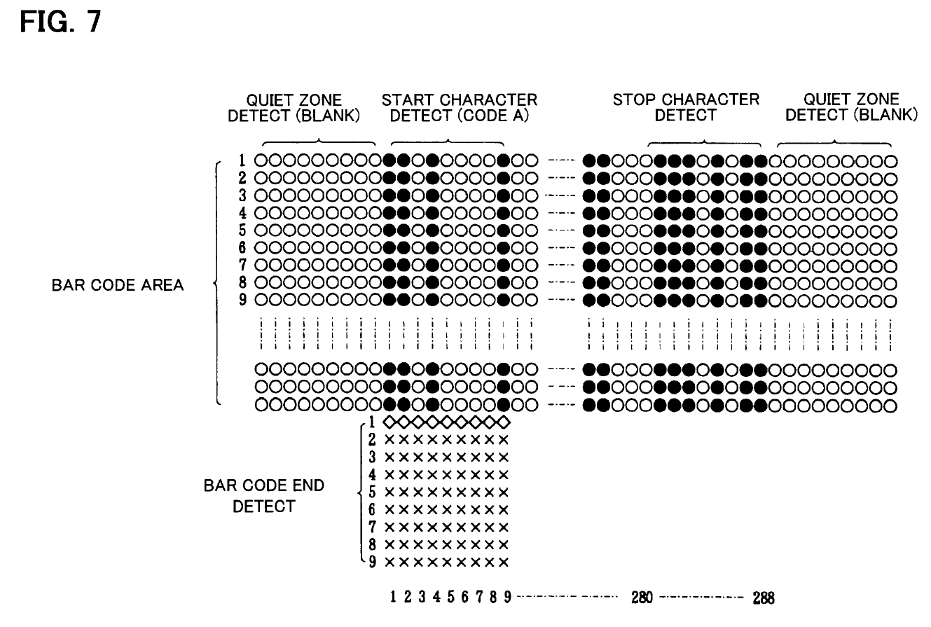

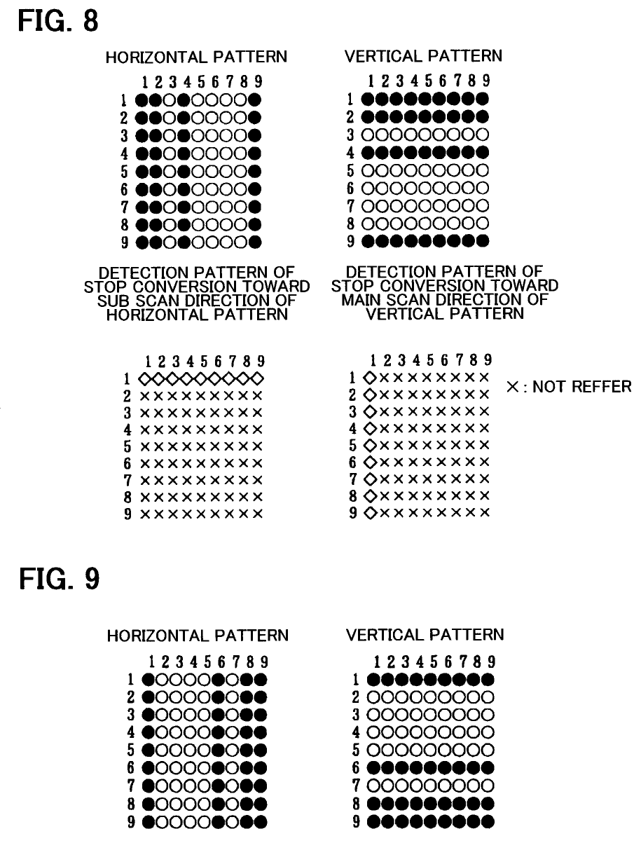

So in the present invention, the collation size is decreased, and the drop in detection accuracy is prevented even if the collation size is small. FIG. 6 is a flow chart depicting the detecting processing of the pattern decoder, and FIG. 7, FIG. 8 and FIG. 9 are diagrams depicting the operation thereof.

For the collation size, only 9 modules, from the first bar to the last bar, are required to identify the start code and the codes A, B and C in FIG. 5. Since a bar code is horizontally or vertically arranged, the collation size (window size) is decreased to 9×9=81 bits.

As FIG. 4 and FIG. 7 show, it is specified that a blank is provided before the start code of the bar code. So when the blank is detected by the 9×9 detection window, and then when the start code pattern is detected during scanning the window at 9 dot (for a 9×9 window), the start code of the bar code is recognized. By this, a detection error of the start code is prevented.

For the stop code, the number of dots from the start code to the stop code is specified, as shown in FIG. 4 and FIG. 7. In other words, the number of dots from the start code to the stop code is specified to 288 dots. Therefore the number of scanned dots of the window, from the start code detection to the stop code detection, is counted, and when the pattern of last 9 modules in the stop code (see FIG. 9) is detected and the number of counted dots is the specified 280 dots from the start code detection at this time, the stop code is recognized, and bar code data is recognized.

Since the window size is decreased, the end of the bar code in the sub-scanning direction must be detected. As FIG. 7 shows, it is detected that the first line of the 9×9 window is a pattern (e.g. all space) which is different from the pattern of the first line of the bar code in a range judged as the bar code area in the main scanning direction, whereby the end of the bar code area in the sub-scanning direction is recognized.

The above example described detection when the bar code is arranged in the horizontal direction, as shown in FIG. 4, but in the case when the bar code in FIG. 4 is vertically arranged as well, the bar code can be detected by scanning the window in the main scanning direction.

In other words, as FIG. 8 shows, the 9×9 vertical pattern of the start code is registered in advance, and when a blank is detected by the 9×9 detection window, and then when the start code pattern is detected during sub-scanning of the window at 9 line (for a 9×9 window), the start code of the bar code is recognized. By this, a detection error of the start code is prevented.

For the stop mode, the number of dots from the start code to the stop code is specified, as shown in FIG. 4 and FIG. 7. In other words, the number of dots from the start code to the stop code is specified to 288 dots. Therefore the number of sub-scanned dots of the window from the start code detection to the stop code detection is counted, and when the pattern of last 9 modules in the stop code (see FIG. 9) is detected and the number of counted dots at this time is 280 dots from the start code detection, the stop code is recognized, and it is confirmed that this data is bar code data.

Since the window size is decreased, the end of the bar code in the main scanning direction must be detected for a vertical bar code. As FIG. 8 shows, it is detected that the first row of the 9×9 window is a pattern (e.g. all space) which is different from the pattern at the first line of the bar code in the main scanning direction, whereby the end of the bar code area in the main scanning direction is recognized.

Horizontal bar code detection processing of the pattern decoder 344 will now by described with reference to FIG. 6.

(S10) The 9×9 detection window is scanned in the main scanning direction, which is collated with a blank pattern, and it is judged whether the pattern is a blank pattern.

(S12) When the 9 dot window (for 9×9 window) is scanned after the blank is detected, the 9×9 pattern of the detection window and the start code pattern are collated, and it is judged whether it is a start code pattern. If the start code pattern is not detected, processing returns to Step S10.

(S14) If it is judged as a start code pattern, it is recognized as the start code of a bar code, and the counting of the number of scanned dots of the bar code area counter starts.

(S16) The pattern of the 9×9 detection window and the stop code pattern are collated.

(S18) When the stop code pattern is not detected, it is judged whether the number of counted dots exceeds the predetermined value (280). If the number of counted dots does not exceed a predetermined value, processing returns to Step S16, and if the number of counted dots does exceed a predetermined value, it is judged that the area is not a bar code area.

(S20) When a last 9 module pattern in the stop code (see FIG. 9) is detected, it is judged whether the number of counted dots is a predetermined 280 dots from the start code detection, and if the number of counted dots is a predetermined value (280), it is recognized as the stop code, and it is confirmed that this data is bar code data. If the number of counted dots is not a predetermined value (280), processing returns to Step S16, since this may be data other than bar code data.

In this way, a bar code can be detected without a detection error using a small size detection window. A bar code can also be detected when a horizontal or vertical bar code is rotated 180 degree.

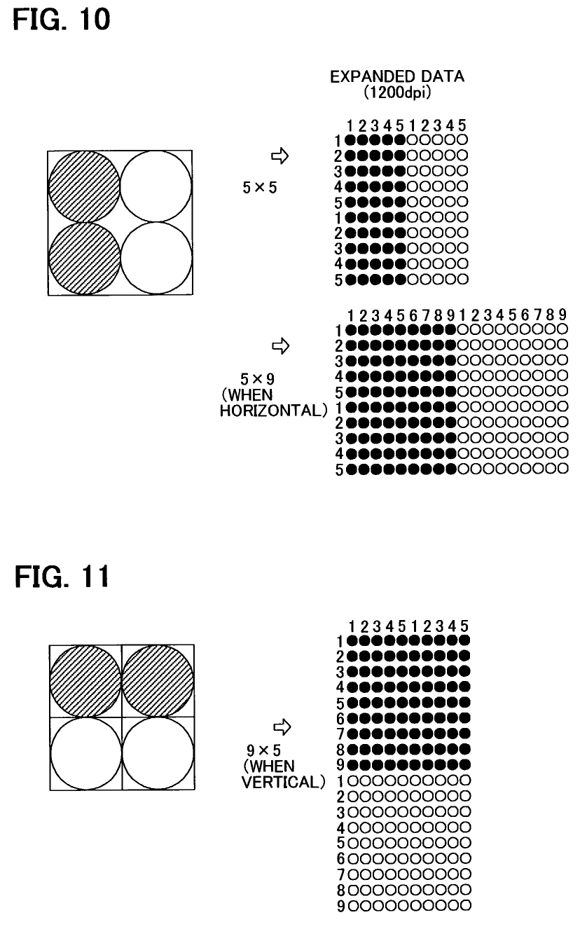

The data expanding unit converts one dot into 5×5 dots for an area other than the bar code, according to the output of the pattern decoder 344, and converts a bar code in a horizontal direction into 5×9 dots, as FIG. 10 shows. Also as FIG. 11 shows, a bar code in a vertical direction is converted into 9×5 dots.

In this way, a target pattern, such as a bar code, is detected from bit map data with a predetermined print density, and the data can be printed changing the print density for the target pattern part and for a part other than the target pattern part.

[Print Density Converting Mechanism of First Embodiment]

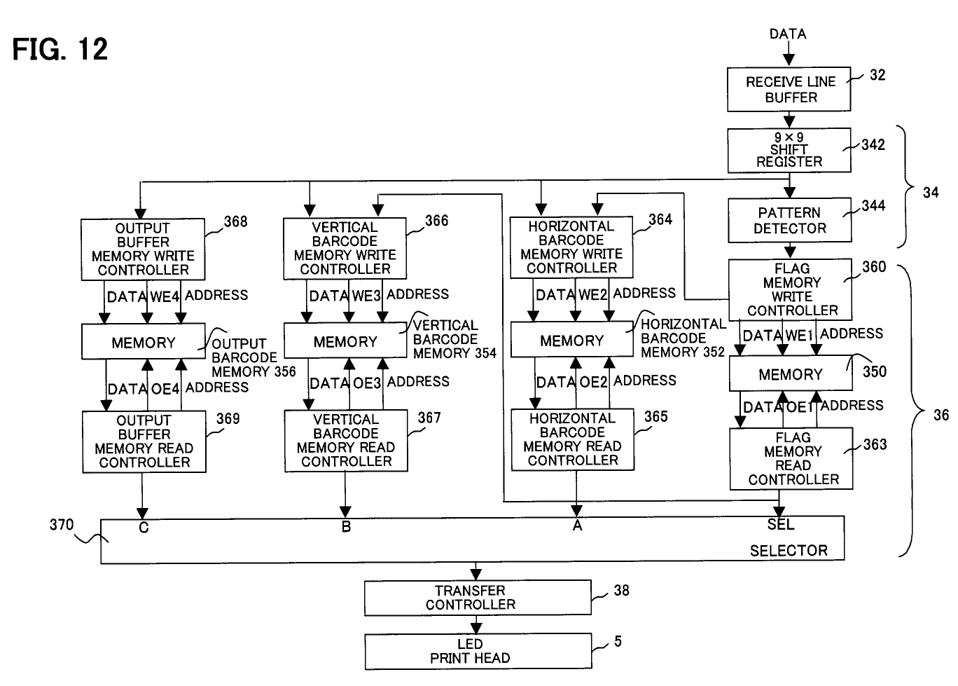

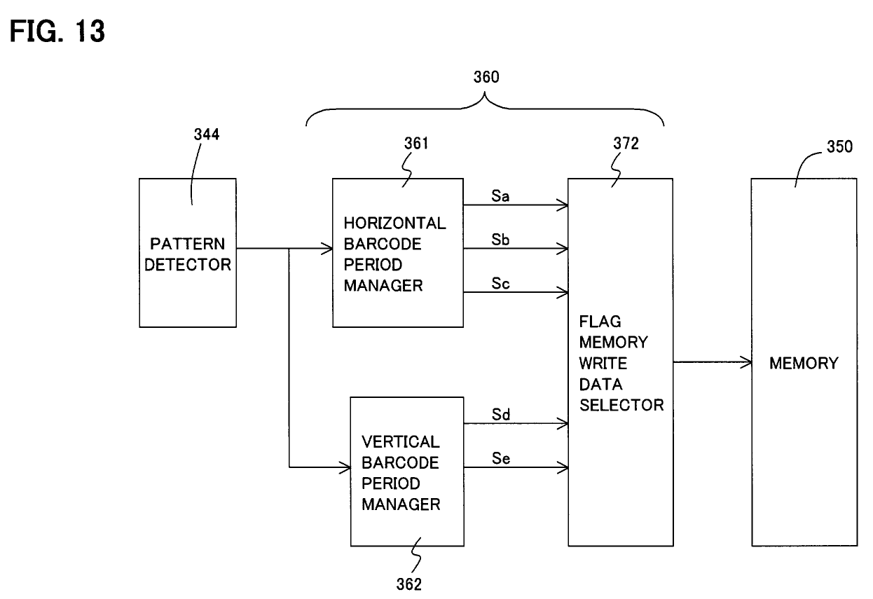

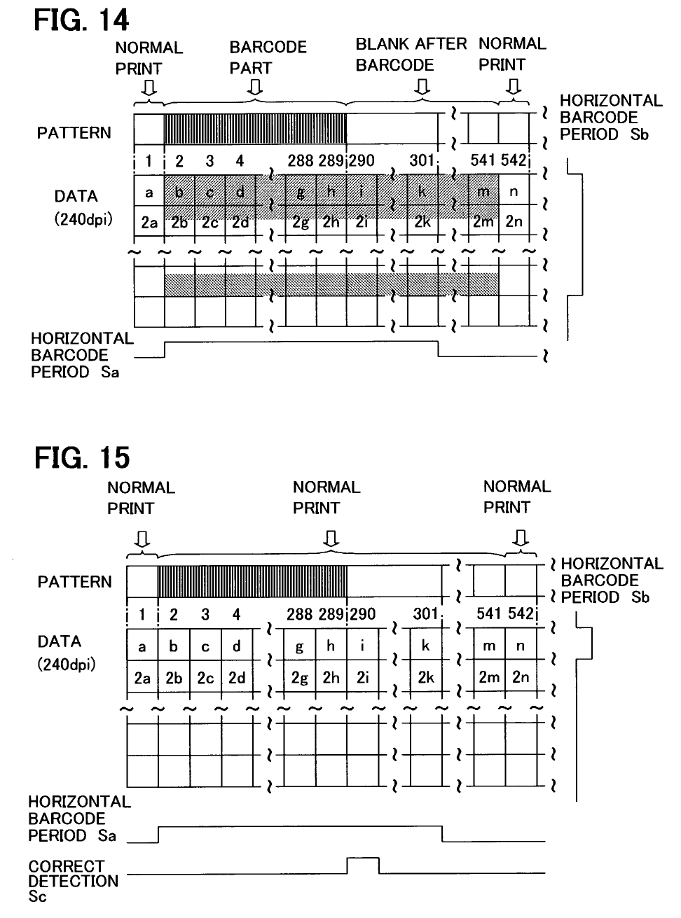

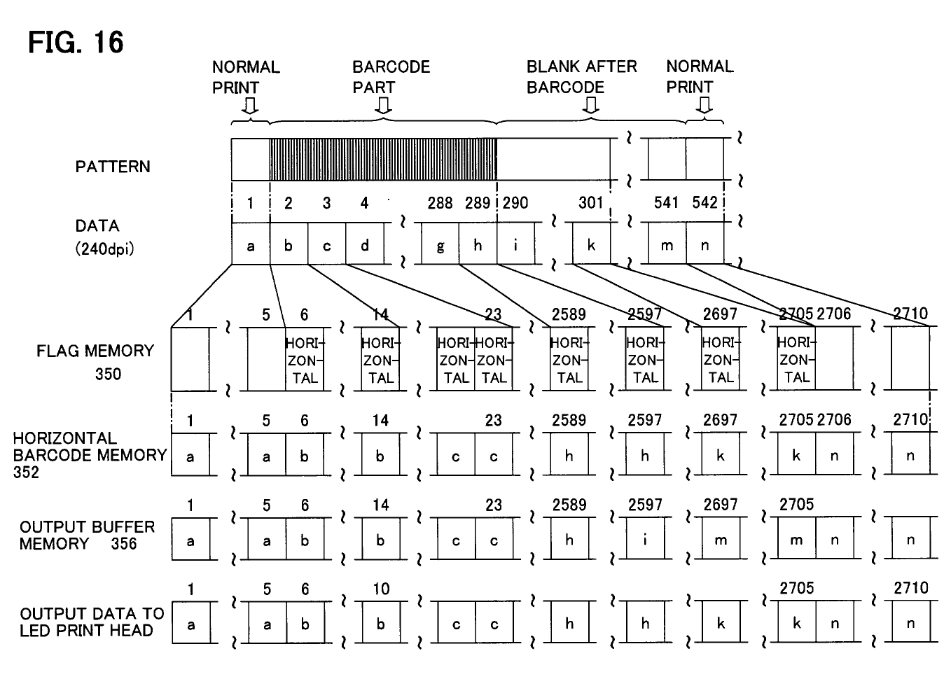

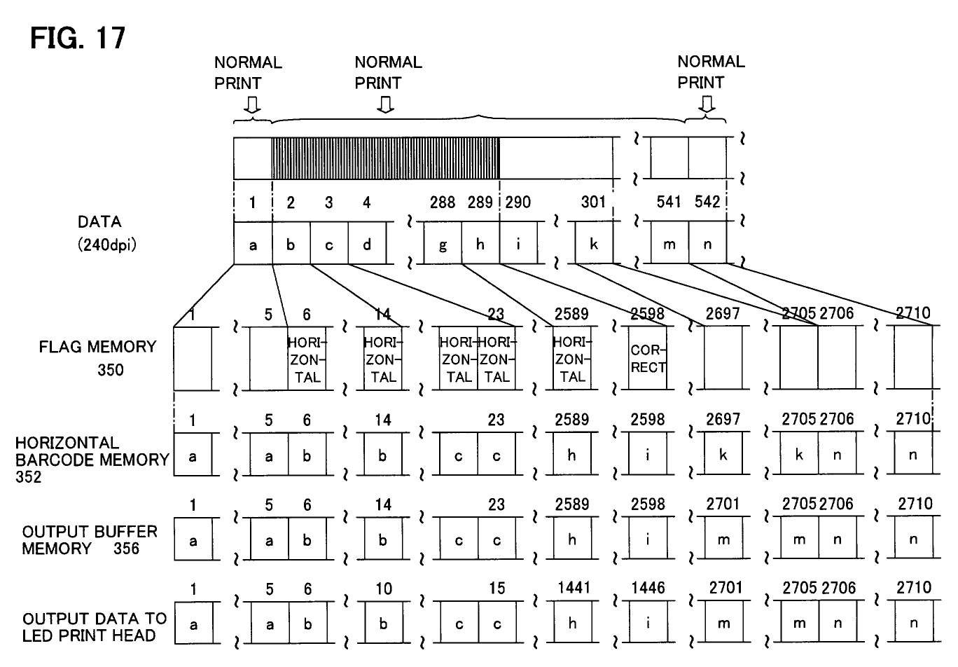

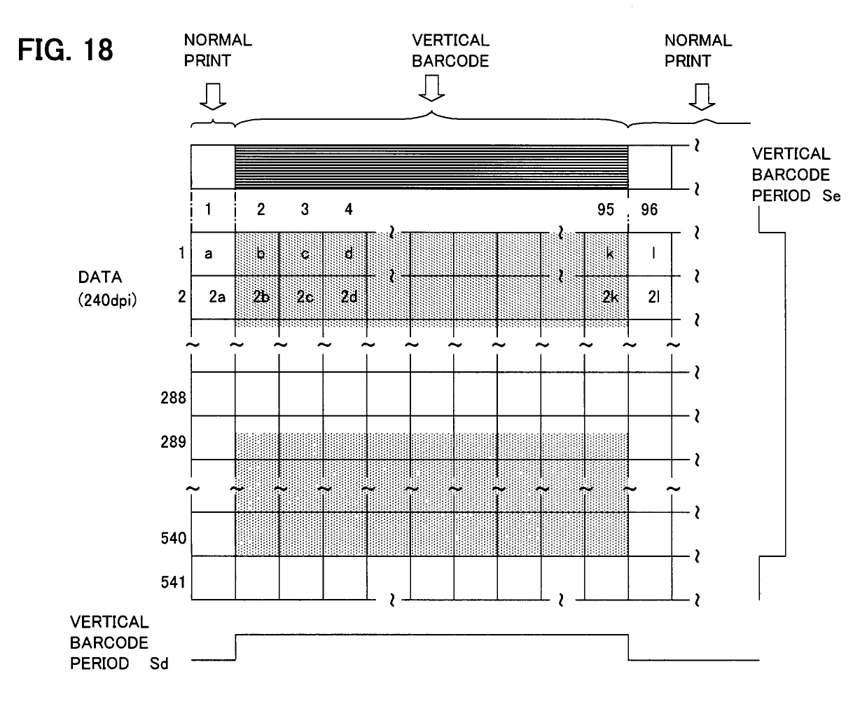

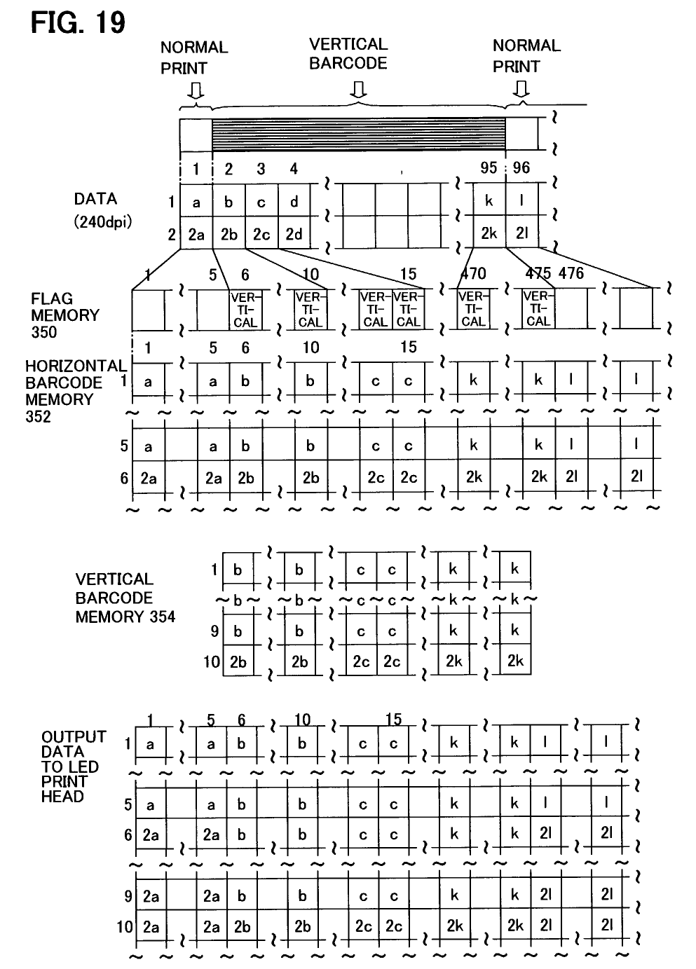

Now the print density converting mechanism will be described in detail. FIG. 12 is a block diagram depicting the data expanding unit (print density converting unit) 36 in FIG. 1 according to the first embodiment, FIG. 13 is a block diagram depicting the flag write controlling unit in FIG. 12, FIG. 14 and FIG. 15 are diagrams depicting the flag writing unit, FIG. 16 and FIG. 17 are diagrams depicting operation during horizontal bar code detection, and FIG. 18 and FIG. 19 are diagrams depicting operation during vertical bar code detection.

The print density converting mechanism in FIG. 12 has a configuration where data expansion is executed in parallel with horizontal bar code detection, so that print data to the LED is generated at high-speed. The receive line buffer 32 and the bar code detecting unit 34 are described in FIG. 1, and the 9×9 shift register 342 and the pattern detecting unit (pattern decoder) 344 are as described in FIG. 3.

The data expanding unit 36 has a flag memory 350, flag memory write controlling unit 360, and flag memory read controlling unit 363. The flag memory 350 holds 21600 bits (21.6 k bits) of flags, which is the number of bits for the width when the 1200 dpi LED head 5 executes printing with an 18 inch width. In this example, the flag memory 350 is comprised of two lines of memory, where write and read are executed alternately. There are three types of flags, that is, horizontal, vertical, and correction, as described in FIG. 16 to FIG. 19.

The data expanding unit 36 has three data memories, that is, a horizontal bar code memory 352 for holding expansion data, vertical bar code memory 354, and output buffer memory 356. The horizontal bar code memory 352 and the output buffer memory 356 have 21600 bits (21.6 k bits) of data, which is data for the print width respectively, and in this example, the horizontal bar code memory 352 is comprised of two lines of memory where write and read are executed alternately. The output buffer memory 356 is installed to the output corrected data, in the case of the above mentioned correction of bar code detection.

The vertical bar code memory 354 is for storing bar code data which is expanded in the vertical direction, and holds data of the number of bits for the height of a bar code (e.g. 500 bits)×9 bits.

In this horizontal bar code memory 352, the horizontal bar code memory write controlling unit 364 and the horizontal bar code memory read controlling unit 365 are installed. In the same way, in the vertical bar code memory 354, the vertical bar code memory write controlling unit 366 and the vertical bar code memory read controlling unit 367 are installed. Also in the output buffer memory 356, the output buffer memory write controlling unit 368 and the output buffer memory read controlling unit 369 are installed.

The data selector 370 selects the read output from one of horizontal bar code memory 352, vertical bar code memory 354, and output buffer memory 356 according to the flag which is read from the flag memory 350, and outputs the read data to the transfer controlling unit (LED head interface converting unit) 38.

As FIG. 13 shows, the flag memory write controlling unit 360 is comprised of a horizontal bar code period managing unit 361 which receives the output of the pattern detecting unit 344 and manages the horizontal bar code period, a vertical bar code period managing unit 362 which receives the output of the pattern detecting unit 344 and manages the vertical bar code period, and a data select unit 372 which writes the flag memory 350 based on these outputs.

The horizontal bar code period managing unit 361 turns the horizontal bar code main scanning period signal Sa ON during a predetermined period (in this case, 288 dots+12 dots at 240 dpi ) according to the detection of the start code of the horizontal bar code, as shown in FIG. 14 and FIG. 15, turns the horizontal bar code sub-scanning period signal Sb ON according to the detection of the start code of the horizontal bar code, and turns the horizontal bar code sub-scanning period signal Sb OFF according to the detection of the horizontal bar code correction and horizontal bar code end. The managing unit 361 outputs the correction detection signal Sc according to the detection of the horizontal bar code correction, as shown in FIG. 15.

The vertical bar code period managing unit 366, on the other hand, turns the vertical bar code main scanning period signal Sd ON during a predetermined period (in this case, 94 dots at 240 dpi , which is the height of the bar code), according to the detection of the start code of the vertical bar code, as shown in FIG. 18, turns the vertical bar code sub-scanning period signal Se ON according to the detection of the start code of the vertical bar code, and turns the vertical bar code sub-scanning period signal Se OFF according to the detection of the stop code of the vertical bar code.

Now the print density converting operation for a horizontal bar code will be described with reference to FIG. 16 and FIG. 17. As FIG. 16 shows, for example, there is a horizontal bar code at the 289^{th} dot from the 2^{nd} dot in the main scanning direction at 240 dpi . When the above mentioned main scanning period signal Sa of the flag memory write controlling unit 360 is OFF, the address is updated in 5 bit units in the flag memory 350, and when the main scanning period signal Sa is ON, 9 bits of horizontal flags are written.

In the case of the horizontal bar code memory write controlling unit 364, on the other hand, when the main scanning period signal Sa of the flag memory write controlling unit 360 is OFF, the one dot output of the shift register 342 is expanded to five dots, and when the signal Sa is ON, one dot output is expanded to 9 dots, which are written to the horizontal bar code memory 352. The output buffer memory write controlling unit 368 expands one dot of the shift register 342 to five dots, which are written to the output buffer memory 356.

When writing of one line data at 240 dpi to the memories 352 and 356 ends, the reading controlling sections 363, 365 and 369 starts reading the memories 350, 352 and 356 respectively. The selector 370 selects the output of the memory 352 or memory 356 depending on the flag of each bit of the flag memory 350.

Therefore as FIG. 16 shows, when the flag of the flag memory 350 indicates horizontal, the data of the horizontal bar code memory 352 is selected, and when the flag of the flag memory 350 does not indicate horizontal, the data of the output buffer memory 356 is selected, which becomes the output data to the LED head. The reason why 252 dots of blank exists after the bar code part is because the data of the output buffer memory 356 synchronizes such that the first data “n” of the normal print area comes at the 2706^{th} dot after the 2705^{th} dot in the flag memory 350 at the point when the horizontal bar code main scanning period Sa ends (that is, the 301^{st} dot at 240 dpi in FIG. 16), and the 302^{th} dot to the 541^{st} dot in the blank are dummy dots for synchronization.

As FIG. 17 shows, the horizontal flag for the read output in the flag memory 350 is disabled by this correction flag, so the data of the output buffer 356 is selected, which becomes the output data to the LED head.

Now the print density converting operation of a vertical bar code will be described with reference to FIG. 19. As FIG. 19 shows, there is a vertical bar code from the 2^{nd} dot to the 95^{th} dot in the main scanning direction at 240 dpi . When the main scanning period signal Sd of the above mentioned flag memory write controlling unit 360 is OFF, addresses of the flag memory 350 are updated in 5 bit units, and when ON, 5 bits of the vertical flag is written.

The horizontal bar code memory write controlling unit 364, on the other hand, expands one dot output of the shift register 342 to five dots, and writes it to the horizontal bar code memory 352. The vertical bar code memory write controlling unit 366 expands the one dot of the shift register 342 to 9 dots in the vertical direction when the vertical flag of the flag memory 350 is ON, and writes it to the vertical bar code memory 354.

When writing one line data at 240 dpi to the memories 352 and 356 ends, the read controlling unit 363, 365 and 367 start reading each memory 350, 352 and 354. The selector 370 selects the output of the memory 352 or memory 354 depending on the flag of each bit of the flag memory 350.

Therefore when the flag of the flag memory 350 does not indicate vertical, as shown in FIG. 19, the data of the horizontal bar code memory 352 is selected, and when the flag of the flag memory 350 indicates vertical, the data of the vertical bar code memory 354 is selected, which becomes the output data to the LED head.

Since the detection and the data expansion are executed at the same time in this way, print density conversion can be performed at high-speed. Also because of the output buffer memory, the expansion result can be used for correction of bar code detection.

[Print Density Converting Mechanism of Second Embodiment]

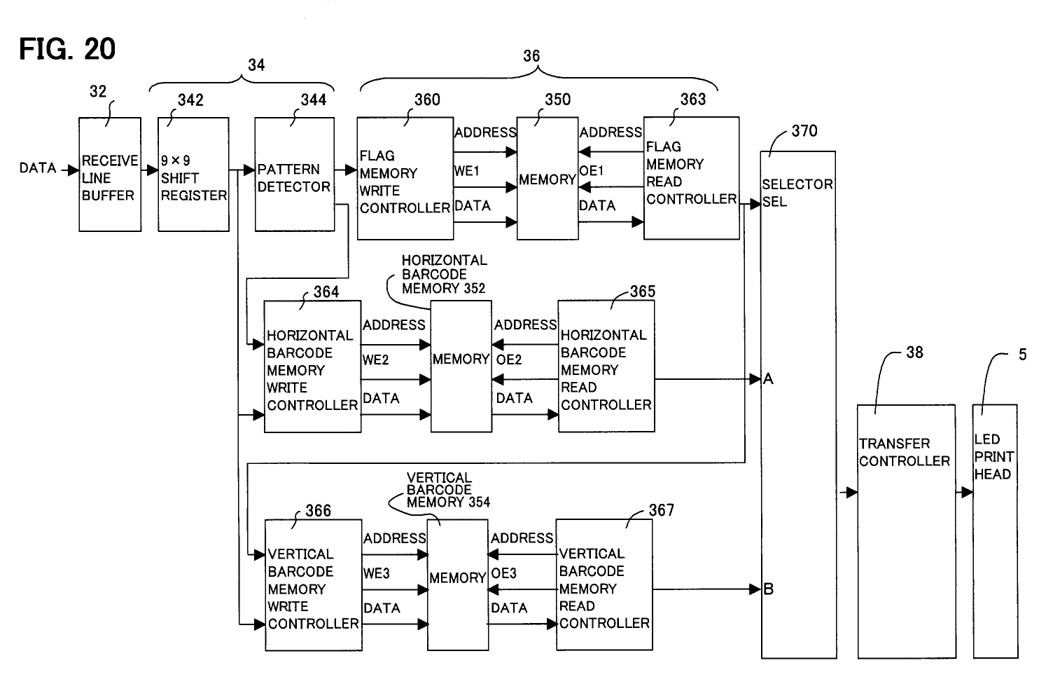

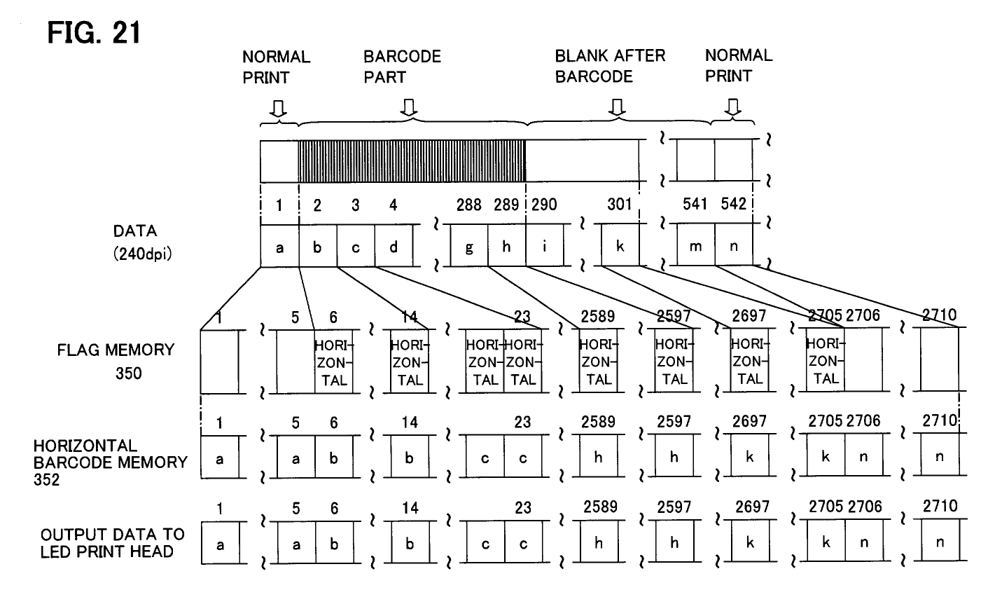

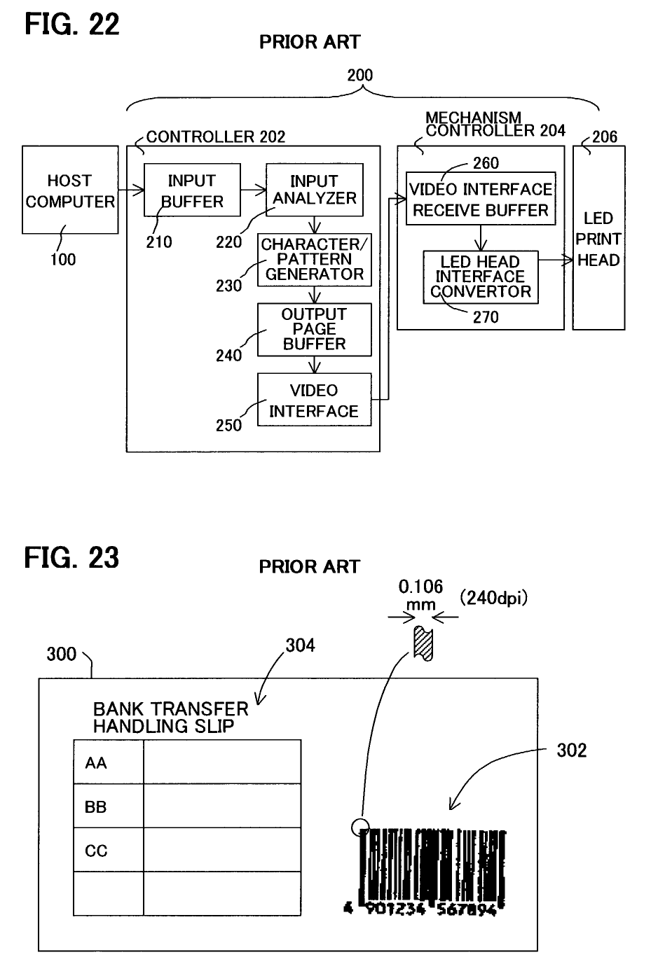

Now another print density converting mechanism will be described in detail. FIG. 20 is a block diagram depicting the second embodiment of the data expanding unit (print density converting unit) 36 in FIG. 1, and FIG. 21 is a diagram depicting operation during the horizontal bar code detection.

The print density converting mechanism in FIG. 20 also has a configuration to execute data expansion in parallel with detection of the horizontal bar code, and generates the print data to the LED head at high-speed. The receive line buffer 32 and the bar code detecting section 34 are described in FIG. 1, and the 9×9 shift register 342 and the pattern detecting unit (pattern decoder) 344 are as described in FIG. 3.

The data expanding unit 36 has a flag memory 350, flag memory write controlling unit 360, and flag memory read controlling unit 363. The flag memory 350 holds 21600 bits (21.6 k bits) of flag data, which is the number of bits for the width when the LED head 5 at 1200 dpi executes printing with an 18 inch width. In this example, the flag memory 350 is comprised of two lines of memory, where write and read are executed alternately. The flag has two lines, horizontal and vertical.

The data expanding unit 36 has two data memories, that is, a horizontal bar code memory 352 and a vertical bar code memory 354 for holding the expansion data. The horizontal bar code memory 352 holds the 21600 bits (21.6 k bits) of data for the print width, and in this example, the horizontal bar code memory 352 is comprised of two lines of memories, where write and read are executed alternately. In this example, correction is not executed, so the output buffer memory 356 is deleted.

The vertical bar code memory 354 is for storing bar code data which is expanded in the vertical direction, and holds the number of bits for the height of the bar code (e.g. 500 bits)×9 bits of data.

Then for this horizontal bar code memory 352, the horizontal bar code memory write controlling unit 364 and the horizontal bar code memory read controlling unit 365 are installed. In the same way, in the vertical bar code memory 354, the vertical bar code memory write controlling unit 366 and the vertical bar code memory read controlling unit 367 are installed.

The data selector 370 selects the read output of either the horizontal bar code memory 352 or the vertical bar code memory 354 according to the flag read from the flag memory 350, and outputs the data to the transfer controlling unit (LED head interface converting section) 38.

As FIG. 21 shows, in this configuration, the horizontal bar code detection correction is not executed, so the print density converting operation of the horizontal bar code, just like FIG. 16, is executed. In the case of the vertical bar code, the operation is the same as FIG. 19. According to the present embodiment, the circuit scale can be simplified, which is an advantage.

[Other Embodiments]

The printer of the present invention has been described using an electro-photographic printer which forms toner images on a print medium, but the present invention can be applied to other types of printers. Also the print medium has been described using continuous paper, but the present invention can be applied to such cut medium as cut paper, and the medium is not limited to paper, but may be another medium such as film.

The present invention has been described with the above mentioned embodiments, but various modifications are possible within the spirit of the present invention, and these modifications are not excluded from the scope of the present invention.

As described above, the present invention exhibits the following effects.

Since the pattern for which print density should be converted is detected from the bit map data, and the number of data expansion bits is changed, a print density of an area of a specified pattern in a page can be changed from a print density of the other area. Therefore it is possible to implement without changing the print resource and command system at the host side, and without changing bit map development processing and the bit map development density of the printer controller.

As a consequence, the present invention can be implemented merely by changes at the printer side without changing the user system, and can be implemented at low cost without increasing the processing speed of the controller and the memory capacity very much.

What is claimed is:

1. A printer control apparauts for generating bit map data according to print data, and outputting the bit map data to a printer engine, comprising:
a memory for storing bit map data which is developed at a predetermined print density;
a pattern detecting unit for scanning the data of said memory by a predetermined detection window and detecting a pattern for which print density is changed; and
a print density converting unit for expanding said bit map data by changing the number of data expansion dots of the bit map data of said pattern from the number of data expansion dots of the bit map data of an area other than said pattern according to said detection result.

2. The printer control apparatus according to claim 1, wherein said pattern detecting unit detects a start pattern and a stop pattern of a bar code, and
said print density converting unit expands said bit map data by increasing the number of data expansion dots of the bit map data of an area sandwiched between said start pattern and stop pattern to be more than the number of data expansion dots of the bit map data in an area other than said area.

3. The printer control apparatus according to claim 2, wherein said pattern detecting unit recognizes said start pattern when the pattern of said detection window matches said start pattern at the point when said detection window scanned for a predetermined number of dots after detecting that the pattern of said detection window is a blank pattern.

4. The printer control apparatus according to claim 2, wherein said pattern detecting unit counts the number of dots from the point when said start pattern is detected to the point when the stop pattern is detected and confirms the detection of said bar code according to count number.

5. The printer control apparatus according to claim 2, wherein said print density converting unit expands said bit map data by increasing the number of data expansion dots of said bit map data from said start pattern to be more than the number of data expansion dots of the bit map data of an area other than said area according to the detection of said start pattern.

6. The printer control apparatus according to claim 4, wherein said print density converting unit inhibits the output of the data that increases the number of data expansion dots of said bit map data from said start pattern to be more than the number of data expansion dots of the bit map data of an area other than said area, when said pattern detection section does not confirm said bar code detection.

7. The printer control apparatus according to claim 2, wherein said pattern detecting unit judges whether said bar code is a horizontal bar code or a vertical bar code, and said print density converting unit changes said data expansion direction according to said judgment result.

8. A printer control method for generating bit map data according to print data and outputting the bit map data to a printer engine, comprising the steps of:
developing the bit map data in a memory at a predetermined print density;
scanning the data of said memory by a predetermined detection window and detecting a pattern for which print density is changed; and
print density converting step for expanding said bitmap data by changing the number of data expansion dots of the bit map data of said pattern from the number of data expansion dots of the bit map data of an area other than said pattern according to said detection result.

9. A printer for generating bit map data according to print data and printing the bit map data, comprising:
a memory for storing bit map data developed at a predetermined print density;
a pattern detecting unit for scanning the data of said memory by a predetermined detection window and detecting a pattern for which print density is changed;
a print density converting unit for expanding said bit map data by changing the number of data expansion dots of the bit map data of said pattern from the number of data expansion dots of the bit map data of an area other than said pattern according to said detection result; and
a printer engine for printing said expanded bit map data onto a medium.
